(19) United States
(12) Patent Application Publication
(10) Pub. No.: US 2003/0150147 A1
(43) Pub. Date: Aug. 14, 2003

(54) Device for stretching foil material and poster holder built with said device

(76) Inventor: Rafeal Bieri, Luzern (CH)

Correspondence Address: Edwin D Schindler, Five Hirsch Avenue, P O Box 966, Coram, NY, 11727-0966, US

(21) Appl. No.: 10/276,660

(22) PCT Filed: May 9, 2001
(86) PCT No.: PCT/CH01/00286

(30) Foreign Application Priority Data
May 18, 2000 (CH) 999/00

(51) Int. Cl. G09F 17/00

(52) U.S. Cl. 40/603; 40/607.01

(57) ABSTRACT

A device for stretching foil material and poster holder built with the device includes a guide element and a profile that can be moved and guided crosswise relative to its direction of extension. Two hollow profiles, which are open on their longitudinal sides, extend along the profile with the hollow profiles receiving the edges of the foil material to be stretched. A stretching element is included for stretching the profile crosswise in relation to its direction of extension in any direction in which the hollow profiles are located. The guide element is obliquely mounted on a frame or a structure, so that the profile can be moved or stretched in a transverse direction relative to the direction of extension and obliquely relative to the direction of stretching of the foil material which is to be stretched. The poster holder has at least one such device, which is mounted on a free-standing frame, or forms such a frame, or is mounted on a structure. The stretching profile can be moved and stretched transversal direction relative to its direction of extension and obliquely relative to the direction of stretching of the foil material that is to be stretched. The stretching forces are received solely by the device.

### BACKGROUND OF THE INVENTION

This invention relates to a device by way of which one may tenter tear-proof, sheet material which is equipped at its edges with cord seams into a crease-free, membrane-like surface. Furthermore the invention relates to various poster holders for erecting or constructing posters of tear-proof, sheet material which may be constructed with the help of such devices.

With the sheet material one mainly envisages canvasses which are reinforced with textile fibres or with a textile fabric. Probably the best known is the canvas material used with lorries which is available in different strengths and essentially includes a textile tissue which on both sides is coated with plastic. Already conventionally such canvasses are conventionally equipped with cord seams at their edges which may then be introduced into fitting hollow profiles. A canvas for example is suspended on such a horizontally assembled hollow profile in that its cord is inserted into this hollow profile. If two oppositely lying cord seams are in each case introduced into such a hollow profile then the two hollow profiles may be tensioned away from one another in the transverse direction.

With the tensioning means known up to now it is however not possible to tension a canvas wall with simple means so tightly that the tensioned canvas is permanently tensioned completely free of creases and waves and is smooth as a membrane. And in particular there are no devices with which one could tension several canvasses connected to one another such that there are formed two or more membrane-like, smooth planes running at an angle to one another.

### BRIEF SUMMARY OF THE INVENTION

It is therefore an object of the present invention to provide a simple as possible device which permits the tensioning of tear-proof, sheet material in a manner such that one or more membrane-like smooth surfaces standing at an angle to one another may be formed. Furthermore it is the object of the invention to specify special poster holders which may be constructed with these devices.

This object is firstly achieved by a device for tensioning tear-proof, sheet material equipped with cord seams, consisting of a guide element and a profile which is displaceably guided thereon in the transverse direction to its running direction and along which there runs at least one hollow profile open at its longitudinal side, for accommodating a cord seam of the sheet material to be tensioned, as well as with tensioning means for tensioning the profile transversly to its running direction in that direction in which the hollow profile is located, wherein the guide element is assemblable at an oblique angle on a frame or built construction so that the profile in the transverse direction to its running direction may be displaced and tensioned at an oblique angle to the tensioning direction of the sheet material to be tensioned.

Furthermore the object is achieved by a poster holder for holding posters of tear-proof, sheet material equipped with cord seams, wherein it comprises at least one device according to claim 1 which is assembled on a free-standing frame or itself forms this or is assembled on a built construction so that the tensioning profile in the transverse direction to its running direction may be displaced and tensioned at an oblique angle to the sheet material to be tensioned, and the tension forces are solely accommodated by the device itself.

### BRIEF DESCRIPTION OF THE DRAWINGS

The device is shown in the drawings by way of one example and various application possibilities of the device for tensioning sheet material, specifically in the form of poster holders are likewise shown. The tensioning device is described subsequently by way of these drawings, and its function is explained. The various shown application possibilities are commented on.

There are shown in

FIG. 1: The device for tensioning two canvasses running at an angle to one another, in a plan view;

FIG. 2: An alternative embodiment of the device for tensioning two canvasses running at an angle to one another, in a plan view;

FIG. 3: A simplist embodiment of the device for tensioning two canvasses running at an angle to one another, in a plan view;

FIG. 4: Four devices in cooperation for tentering a cube of canvas pieces which is open to the top and bottom, in a plan view;

FIG. 5: The cube of canvas surfaces tentered by way of four devices, in a perspective view;

FIG. 6: Thee cube of canvas surfaces tentered by way of four devices, in a front elevation;

FIG. 7A variant of a rectangular cube open to the top and bottom, which is constructed out of four tensioned canvas pieces by way of four devices;

FIG. 8: One variant of a prism-shaped body open to the top and bottom, constructed of three cooperating devices and three canvas pieces connecting these, in a plan view;

FIG. 9: The variant of the prism-shaped body open to the top and bottom, in a perspctive view;

FIG. 10: Three devices for tentering two canvas pieces around a walling or wall corner, in a plan view;

FIG. 11: The variants with three devices by way of which two canvas pieces being at an angle to one another are tensioned around a walling or wall corner, in a perspective representation.

### DETAILED DESCRIPTION OF THE INVENTION

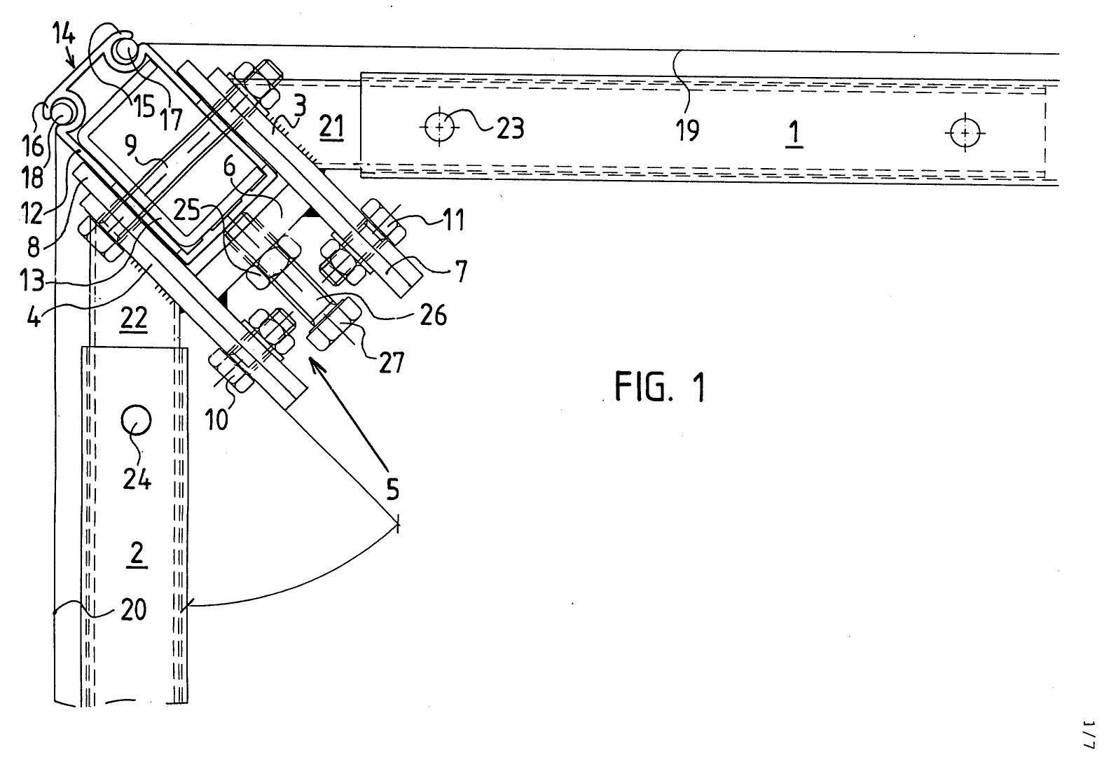

FIG. 1 shows the device for tensioning two canvasses 19, 20 running at an angle to one another. In two struts 1,2 which approach one another and here enclose an angle of 90° there are inserted two end pieces 21, 22. At the free ends of these end pieces 21, 22 there is welded in each case one flat steel 3,4 at an angle of 45° to the respective strut 1,2. A guide element 5 is applied between these two flat steels 3,4. This guide element 5 consists of two flat steels 7, 8 which run parallel to one another and which are welded to one another via a bridge 6. The two flat steels 7,8 in the shown example are screwed to the flat steels 3, 4 by way of three screws 9, 10, 11. With this the two struts 1,2 or the two end pieces 21, 22 are rigidly connected to one another running at 90° to one another and at a defined distance to one another. Between the two flat steels 7,8 which form the side walls of the guide element 5 there is applied an aluminium profile 12 of which one sees a cross section here. For its reinforcement, in the shown example a U-steel-profile 13 is applied into the aluminium profile 12. In place of a U-profile 13 one may just as easily insert a rectangular tube of steel, which obviously would be somewhat heavier. On the front side 14 of the aluminium profile 12 which forms the outer edge of the two approaching struts 1,2 and end pieces 21, 22, along its two edges, in each case there is formed out a hollow profile 15, 16. The aluminium profile at the factory on manufacture is drawn directly with such a cross section so that these two hollow profiles 15, 16 are formed out as one piece. The cord 17, 18 of the bordering canvas piece 19, 20 is pulled into each hollow profile 15, 16. The cords 17, 18 are attached in the conventional manner along the edges of the canvas pieces 19, 20. Often a solid rubber profile circular in cross section or a string in the form of a wire or a wire strand is welded into a hem in order to form these cords. The canvas pieces 19, 20 run on the other side of the device out of the drawing and thus here one does not see that they are rigidly anchored here. This anchoring in a similar manner may be realised by way of a cord seam which is introduced into the hollow profile of a rigidly assembled aluminium profile. The end pieces 21, 22 are inserted longitudinaly displaceable in the struts 1,2 which simultanously act as distance tubes which extend over the length of the canvas piece 19, 20 to be tensioned in each case. For tensioning the canvas pieces 19, 20 firstly both end pieces 21, 22 by hand are moved out of the struts 1,2 as far as possible and then fixed by way of a screw 23, 24. At the same time the canvas pieces 19, 20 are provisionally tensioned somewhat. The actual tight tensioning is now effected in that the reinforced aluminium profile 12 is moved outwards in the direction towards its front side 14, wherein at the same time it is led between the two side walls 7, 8 of the guide element 5. In order to be able to tension the aluminium profile 132 with a large force to the outside, a nut 25 is welded on the rear side of the bridge 6 in which there is inserted a screw 26. In the shown example this screw 26 has a hexagonal head 27 so that it may be rotated by a large torque with a spanner. Of course another screw head would be possible for example a hexagonal socket head screw. In order to accomplish this tensioning alternative means may also be realised. Thus for example a clamping lever with an eccentric may be assembled pivotable about the bridge so that with an applied clamping lever the eccentric presses against the profile 12. In this case one does not require a tool in order to tension the canvasses or to release their tensioning again. With a displacement of the aluminium profile 12 towards the outside, independently of how this is effected, the two canvas pieces 19, 20 held on both sides on the hollow profiles 15, 16 are tensioned. By way of the angular arrrangement, that is to say by way of the fact that tension direction is effected at an angle of 45° to the canvas plane, there results a force transmission ratio. The force F acting in the tensioning direction of the profile with an angle to the canvas plane of α effects a tensioning force of F/cosα. The tensioning force of the tension profile 12 is therefore reinforced in the shown example by the factor 1.41. If in the shown example, where the angle α=45° one presses the profile 12 with 1000N in the direction of its front side 14, there results a tensioning force of about 1400N in the plane of the canvas if only one canvas needs to be tensioned. Since there are two arranged symmetrically to the tension profile 12, the tension force in the two planes of the canvas is in each case half, thus 700N. This tension force is now distributed over the whole width or height of the canvas which extends in the drawing at a right angle to the plane of page of the drawing since the profile 12 is selected in its length such that it encompasses the wide edge of the canvas over the whole canvas width or of the whole height of the perpendicularly tentered canvas. In practice two or more devices as shown in FIG. 1 are arranged over one another so that the tensioning profile 12 is tensioned to the outside at several locations by a screw 26. The sum of the acting tension forces must then be divided by the canvas width or canvas height, which finally results in the tensioning force per width section of the canvas. If therefore for tensioning two pieces of canvas 19, 20 each with a width or height of 4 m which at the other end are rigidly anchored, one were to use two devices arranged over one another as shown in FIG. 1, then with a tensioning force of 1000N which is mustered by each of the two screws 26 then a tensioning force of

$${F}_{B} = \frac{2 ( devices ) \times 1000 N}{cos {45}^{°} \times 2 ( canvasses )}$$

would act on each canvas, that is to say 700N. If each canvas has a height of 4 m then there would thus result a tensioning force per width unit of 700N/4 m=175N per metre.

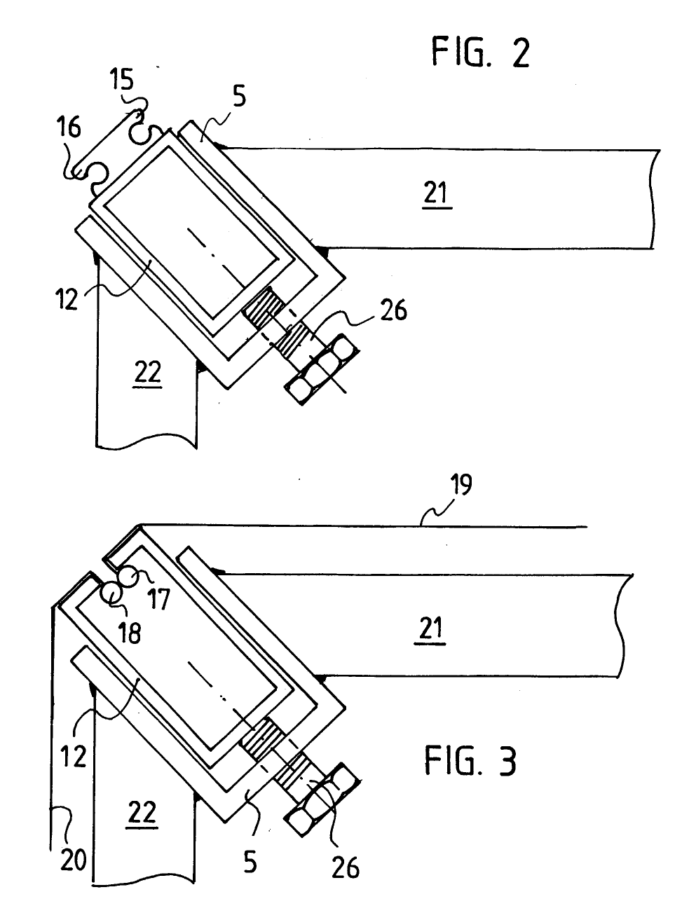

In an alternative embodiment form which is shown in FIG. 2 in place of an aluminium profile 12 drawn complete with hollow profiles one may also apply a square tube 12 onto which along the one narrow side a profile rail with one or two hollow profiles 15, 16 for accommodating cord seams may be screwed, welded or stuck. The guide element 5 too as shown here may be designed even more simply in that it consists of a U-shaped piece which is directly welded on the two end pieces 21, 22. The connecting limb of the U-piece forms the bridge which is passed through by the tensioning screw 26 which impinges the square tube 12. The end pieces 21, 22 may then be introduced into distance tubes of any length.

In the most simple embodiment as is shown in FIG. 3 the profile 12 may even consist of only one square steel tube or square aluminium profile which along its one narrow side comprises a slot so that it itself simultaneously acts as a hollow profile. The cords 17, 18 of the canvasses 19, 20 may then be simply introduced into this slot as is shown here.

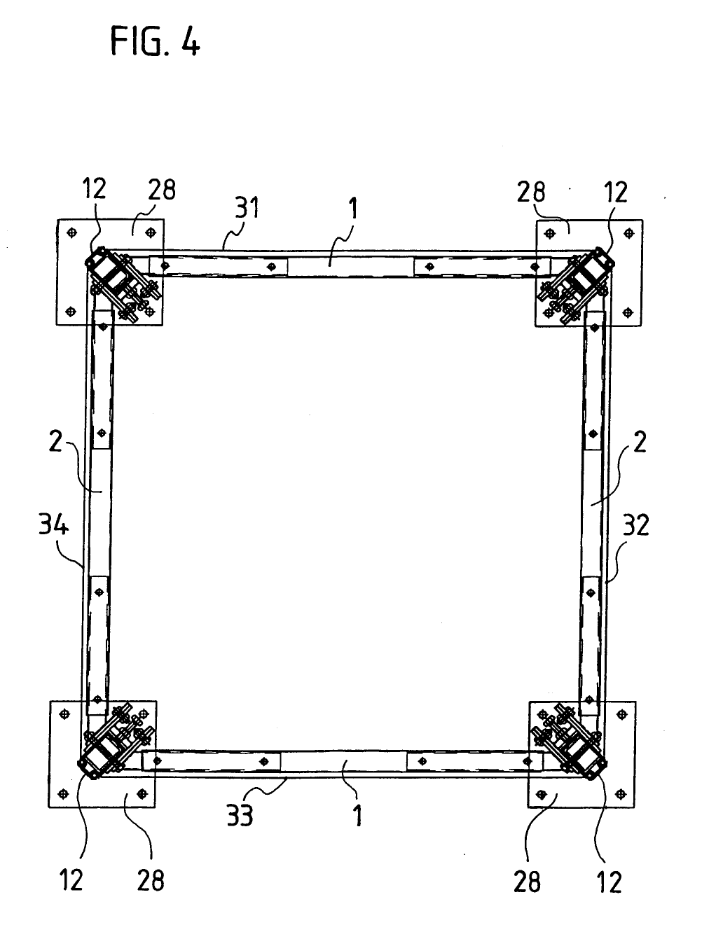

In FIG. 4 there are shown four devices shown cooperating as in FIG. 1 for tentering four canvas pieces 31-34. The devices are connected to one another via square distance tubes 1,2 which act as struts between the individual devices. The tensioning profiles 12 in each case stand below on a base foot 28. These base feet 28 may be screwed onto a rigid floor or they may also be concreted in or buried in the ground. In the latter case they must however be dimensioned larger and be set so deep that canvas walls set up in this manner are anchored secure against storms.

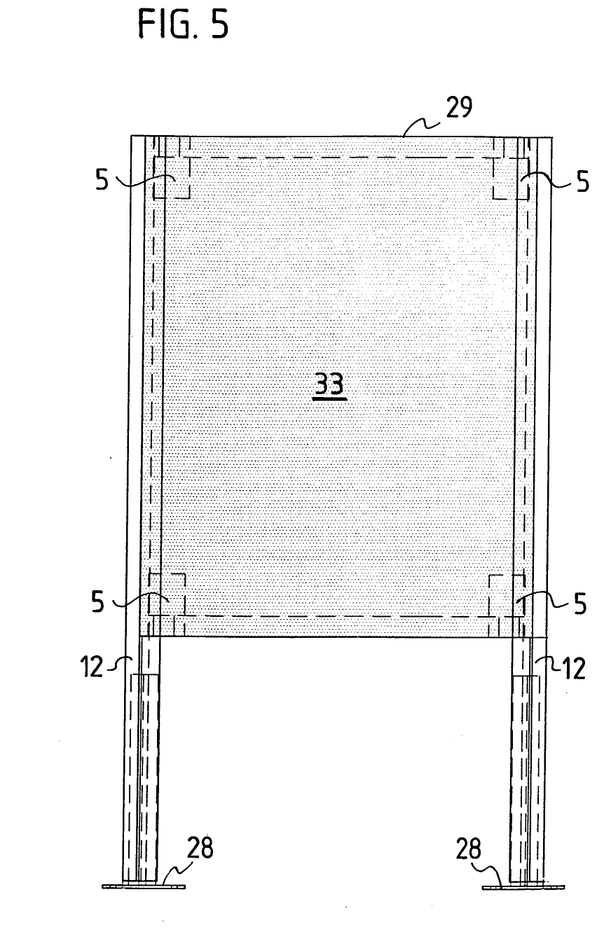

FIG. 5 shows the cube of canvas surfaces tentered by way of four devices. The four tensioning profiles 12 extend from the base feet 28 up to the upper edge 29 of the canvas pieces. They tension these canvas pieces tightly in each case into a membrane-like surface, of which here one may only see one individual canvas sheet 33. The region in the inside of the construction remains free and is open to the top and bottom. According to how high such a cube is designed, or how wide the drawn-in canvas pieces are, one may not only provide tensioning devices on two horizontal planes but on several planes by which mean the tensioning force is correspondingly stronger.

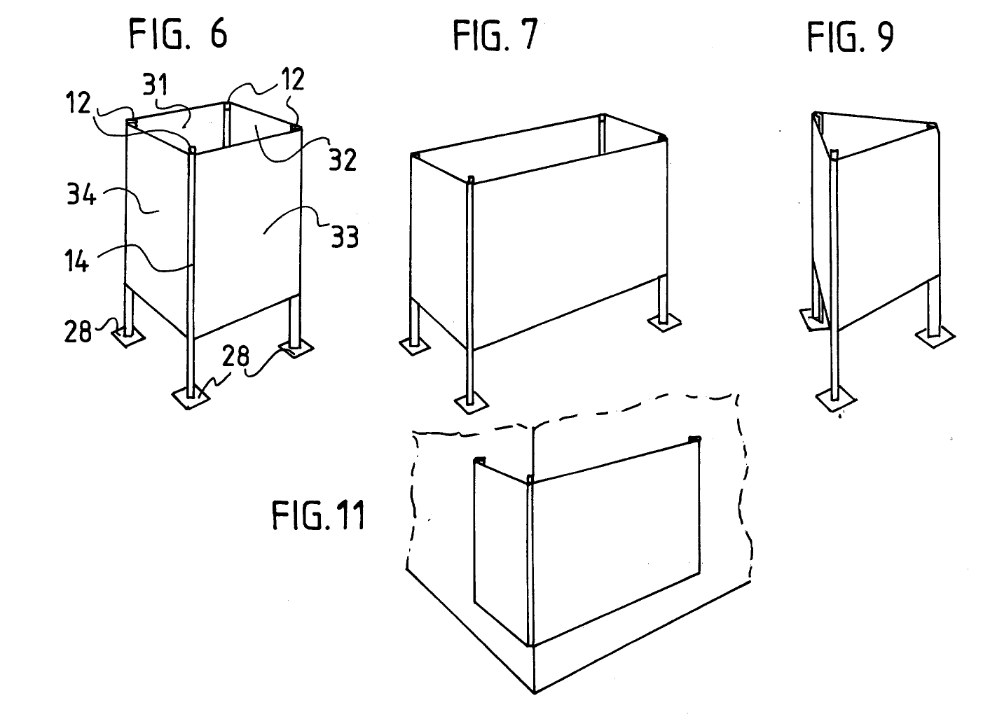

FIG. 6 shows a perspective view of the canvas cube open to the top and bottom which is made in this manner. Such a cube firstly serves as an advertisment poster carrier and is basically a poster holder. The canvas pieces 33, 34 may be directly printed with the advertisment and then drawn into the hollow profiles of the tensioning profiles with the lateral cord seams, whereupon the tensioning profile 12 is tensioned to the outside. The reaction forces are accommodated by the struts or distance tubes between the individual tensioning devices. The canvas pieces on a cube created in such a manner are so tightly tensioned and the transition surfaces of the canvas pieces 33, 34 to the front sides 14 of the tensioning profiles are so smooth that the observer seems sure that the surfaces are of metal or plastic plates. The construction with canvas pieces as a result is much light than if the cube were to be constructed of metal or plastic plates. This design also offers the advantage that the canvas pieces are easily exchangeable and may be rolled for transport. Such a cube may not only be applied as the actual carrier of the advertisment but it may also be used as a sign, as a notice board, as a path marker or as a carrier of one or more company logos. There are many further application possibilities which may not all be listed here. It may serve as a notice board in trade fairs or in exhibitions, but also for communities and tourist locations which image and explain attractions thereon. It may be used as a path marker along trails, wherein one may for example print pictures on the canvas pieces with explanations of the landscape or on peculiarities and attractions which one comes across on the trail. If it is provided with company logos such a cube may for example be set up in front of the entrance to a company building so that one may recognise the company logos from each side when one approaches the entrance. It is clear that such a poster holder may also be screwed onto ceilings or walls by way of its base feet 28 so that it may also be assembled in a suspended manner.

FIG. 7 shows the variant of a rectangular cube open to the top and bottom, which is constructed by way of four devices of four tentered canvas pieces in the same manner, wherein the distance tubes and canvas pieces are simply longer in the one direction than in the other direction.

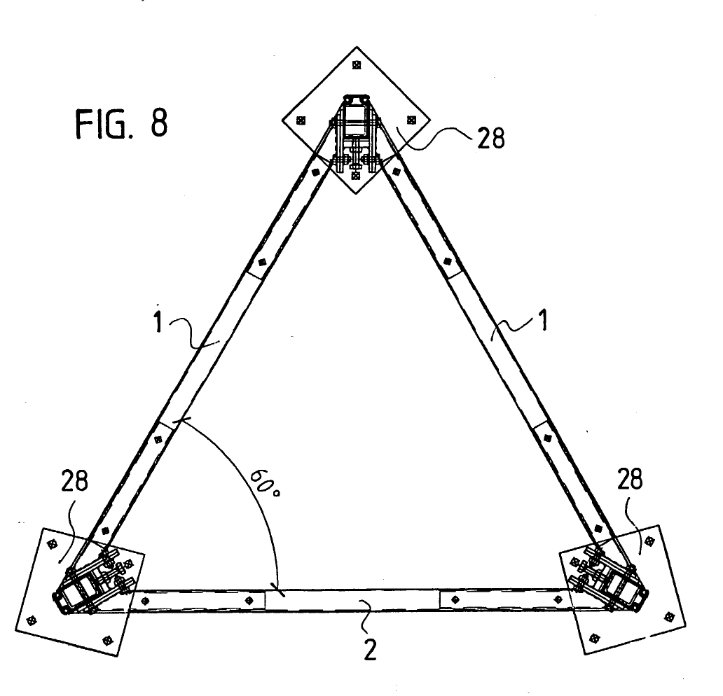

FIG. 8 in a plan view shows three devices for constructing a prism-shaped body. In contrast to the construction according to the previous figures here the struts approach one another such that in each case they enclose an angle of 60° instead of 90°. Everything else is the same. The force transmission ratio changes in that here for each side of an individual canvas piece if F is the tensioning force with which the tensioning profile is pressed to the outside it is calculated as follows: F/cos 30°, that is to say the tensioning force of the profiles is amplified somewhat less on account of the angular relationship, specifically only with by factor 1.15.

FIG. 9 shows the variant of the prism-shaped body open to the top and bottom in a perspective view. In comparison to a cube-shaped advertisment carrier this triangular form is more secure against storms if it is set up outside, and above all it is suitable for setting up on streets and edges of paths in which it is set up with the pointed part in front towards the road. In this manner those approaching by road or on the path view the side facing them at a comfortable angle. Such a triangular body may also be assembled in a hall on the ceiling so that two tensioning profiles run horizontally along the ceiling and one runs displaced downwards. If the view of the people who are on the floor is directed obliquely upwards, the two canvas pieces projecting obliquely downwards are visible at a comfortable angle and are suitable for notices or writings of all types. Indeed devices for tensioning canvas pieces in many different manners in the inside of buildings as well as in the open may be assembled in order to assemble tightly tensioned canvas pieces or posters of canvas material in any manner.

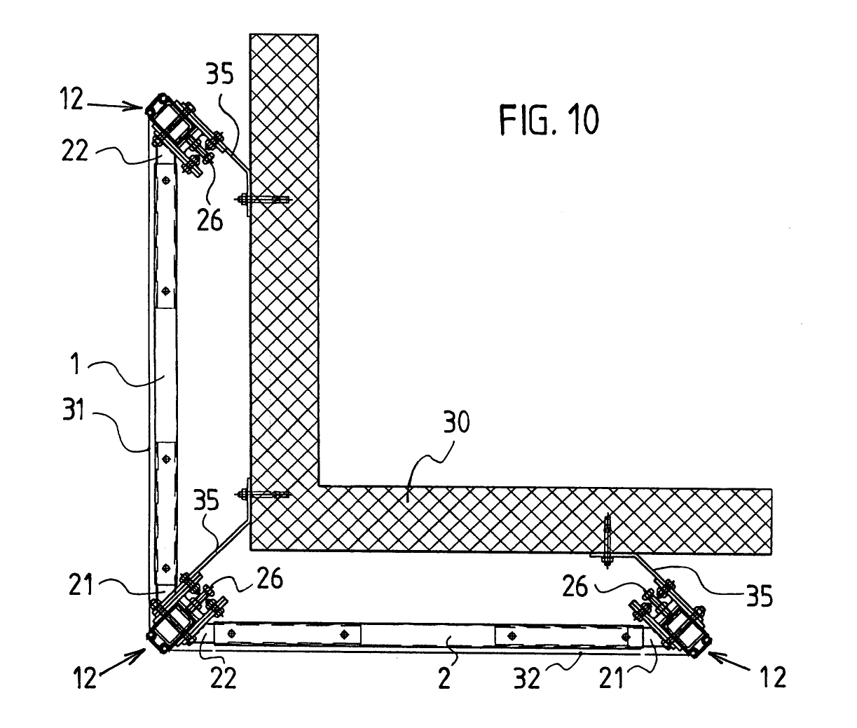

FIG. 10 shows a further variant of the application of this device as a poster holder. Here three devices are applied for tentering two canvas pieces 31, 32 around a walling or wall corner 30, which is shown in the Figure in a plan view. The tensioning devices 12 are screwed on the wall 30 by way of suitable flat steel mountings 25. The individual devices are connected to distance tubes 1,2 in which on both ends there is in each case inserted an end piece 21, 22 in order to adapt the distance to the desired canvas piece length. The canvas pieces 31, 32 from the top to the bottom are pulled with the cord of their side walls into the hollow profiles of the tensioning profiles 12. Thereafter the tensioning profiles 12 are tensioned outwards which is effected with the help of tensioning screws 26.

In FIG. 11 there is shown one variant with canvas pieces tensioned around a walling or wall corner in this manner, in a perspective representation, wherein the one canvas piece is longer than the other. Canvas pieces tensioned in this manner around a wall or walling corner offer a very clean and elegant view since nothing of the tensioning device is visible. Such a poster holder offers the advantage that the canvas pieces or the posters may be exchanged with few hand manipulations and thus new advertisments may be made. The reaction forces of the tension forces acting on the canvas pieces are solely accommodated by the distance tubes and their end pieces and the walling or wall is not loaded in any way. It must only carry the device and the canvas pieces which however are comparatively light.

1. A device for tensioning tear-proof, sheet material equipped with cord seams, consisting of a guide element and a profile which is displaceably guided thereon in the transverse direction to its running direction and along which there runs at least one hollow profile open at its longitudinal side, for accommodating a cord seam of the sheet material to be tensioned, as well as with tensioning means for tensioning the profile transversely to its running direction in that direction in which the hollow profile is located, wherein the guide element is assemblable at an oblique angle on a frame or structure so that the profile in the transverse direction to its running direction may be displaced and tensioned at an oblique angle to the tensioning direction of the sheet material to be tensioned.

2. A device according to claim 1, wherein the guide element comprises two flat steels running parallel to one another at a distance, and is screwed to flat steels welded obliquely on end pieces of struts, wherein the flat steels of the guide element are connected to a bridge, and wherein the tensioning means for tensioning the profile transversely to its running direction consist of a screw which passes through the bridge and impinges the profile.

3. A device according to claim 1, wherein the guide element consists of a U-shaped piece, whose two U-limbs in each case are welded at an oblique angle to the end pieces, and wherein the tensioning means for tensioning the profile transversely to it running direction consists of a screw which passes through the connecting limb on the U-shaped piece and impinges the profile.

4. A device according to one of the preceding claims, wherein the tensioning profile is a drawn, square, aluminium tube on whose one longitudinal side there are formed out one or two open hollow profiles, and in whose inside there is introduced a steel tube as reinforcement.

5. A device according to one of the claims 1 to 3, wherein the tensioning profile is a square steel tube on whose one longitudinal side there is provided a longitduinal slot, so that the tensioning profile itself acts as a hollow profile.

6. A device according to one of the claims 1 to 3, wherein the tensioning profile is a square steel tube on whose one longitudinal side an open hollow profile is formed out or incorporated as one piece.

7. A poster holder for holding posters of tear-proof, sheet material equipped with cord seams, wherein it comprises at least one device according to claim 1 which is assembled on a free-standing frame or itself forms such a frame, or is assembled on a structure, so that the tensioning profile in the transverse direction to its running direction may be displaced and tensioned at an oblique angle to the tensioning direction of the sheet material to be tensioned, and the tensioning forces are accommodated solely by the device itself.

8. A poster holder according to claim 7, wherein it comprises four tensioning profiles which are designed as four parallel, vertically running struts and in each case stand on a base foot, and wherein these tensioning profiles in each case in two guide elements are guided on two horizontal planes and the guide elements of each plane are screwed to end pieces of horizontally running distance tubes which act as struts for accommodating the tensioning forces so that after pulling in and tensioning four canvas pieces there is formed a cube open to the top and bottom.

9. A poster holder according to claim 7, wherein it comprises three tensioning profiles which are formed as three parallel, vertically running struts and in each case stand on a base foot, and wherein these tensioning profiles in each case in two guide elements are guided on two horizontal planes and the guide elements of each plane are screwed to end pieces of horizontally running distance tubes which act as struts for accommodating the tensioning forces so that after pulling in and tensioning three canvas pieces there is formed a body open to the top and bottom with a triangular cross section.

10. A poster holder according to claim 7, wherein it comprises three vertically running tensioning profiles which are guided in each case in two guide elements on two horizontal planes, wherein the guide elements of each plane are screwed to end pieces of horizontally running distance tubes and are screwable via mountings to a wall, wherein the distance tubes act as struts for accommodating the tensioning forces so that after pulling in and tensioning two canvas pieces there is formed an L-shaped poster wall.
